(19) United States
(12) Patent Application Publication
(10) Pub. No.: US 2013/0296013 A1
(43) Pub. Date: Nov. 7, 2013

(54) Skill-Based Amusement Machine With Loss-Biased Jackpot

(71) Applicant: Marc W. Dunbar, Tallahassee, FL (US)

(72) Inventor: Marc W. Dunbar, Tallahassee, FL (US)

(73) Assignee: Tyche Gaming, LLC

(21) Appl. No.: 13/463,340

(22) Filed: May 3, 2012

(51) Int. Cl. A63F 13/00

(52) U.S. Cl. 463/20

(57) ABSTRACT

A gaming machine operating method which promotes customer loyalty by altering the payout on the basis of how many games a particular user has played and lost with a particular gaming provider. In a preferred embodiment, the “jackpot” payout is increased for each game a player loses. The altered jackpot is only made available on machines operated by a particular gaming provider, and is only made available to the player that previously incurred the losses. Thus, when a player experiences a “losing streak” he is given the incentive to continue playing at a particular facility via the fact that the jackpot available to the particular player has been increased.

### BACKGROUND OF THE INVENTION

1. Field of the Invention

This invention relates to the field of gaming. More specifically, the invention comprises a skill-based amusement machine in which the payoff “jackpot” is altered as a function of prior games lost by a defined player.

2. Description of the Related Art

The present inventive method is applicable to a wide variety of amusement devices. It was developed for use in “slot machines,” but it is potentially applicable to a wide variety of other devices. The embodiments disclosed in detail are slot machines, but the invention is by no means limited to these devices.

FIG. 1 shows one physical embodiment of the present invention. The embodiment shown shares many common characteristics with prior art slot machines. However, because it incorporates novel features as well, the view has not been labeled as “prior art.”

Skill-based amusement machine 10 includes an assembly of components attached to chassis 12. Traditional slot machines included mechanical reels and a manually-actuated lever to set the feels in motion. These components have been replaced in the past few decades by video displays. The machine in FIG. 1 includes, no moving reels or other traditional mechanical components. Instead, the game's operation is depicted on primary display 24. The primary display is preferably a high-resolution color display, such as a back-lit LCD. Secondary display 26 may also be provided to show additional information.

The user interacts with the device using player controls 22, which may include “spin” and “stop” buttons. It is also known, in the art to provide a touch-activated overlay on primary display 24. In that case the user simply touches the display itself to operate the machine.

In most gaming applications the player will place a bet by inserting a coin, bill, or credit-transferring device into the machine. Coin slot 14 is provided to receive and authenticate coins. Bill receiver 16 provides the same functions for paper bills. Some gaming providers use optical cards to provide a credit the player can use on a variety of machines. Optical reader/printer 30 is provided to receive this type of conveyance.

Those skilled in the art will know that other types of credit-conveying devices may be used with such amusement machines. A gaming provider may—for example—provide magnetically-encoded cards or physical tokens (“chips”). A receiver suitable for these methods could be provided on the machine as well. Thus, the particular examples depicted for receiving and providing gaming credits should not be viewed as limiting.

The player's winnings are traditionally delivered as coins or tokens in coin tray 20. However, it is also known to provide winnings in the form of a magnetically encoded card or printed paper ticket. It is also known for the amusement machine to automatically transfer the credit for the winnings to a separate device using electronic means.

A significant objective of gaming providers is the building of customer loyalty. Many providers compete with other similarly-situated providers, and it is therefore difficult to promote this objective. The present invention promotes customer loyalty by providing a bonus payout that is unique to each individual player.

### BRIEF SUMMARY OF THE INVENTION

The present invention alters the payout of an amusement machine on the basis of how many games a particular user has played and lost with a particular gaming provider. In a preferred embodiment, the “jackpot” payout is increased for each game a player loses. The altered jackpot is only made available on machines operated by a particular gaming provider, and is only made available to the player that previously incurred the losses. Thus, when a player experiences a “losing streak” he is given the incentive to continue playing at a particular facility via the fact that the jackpot available to the particular player has been altered in a desirable way.

### BRIEF DESCRIPTION OF THE SEVERAL VIEWS OF THE DRAWINGS

FIG. 1 is a perspective view, showing one embodiment of the present invention.

FIG. 2 is an elevation view, showing the operation of a prior art five-reel slot machine.

FIG. 3 is an elevation view, showing paylines available on a prior art five-reel slot machine.

FIG. 4 is an elevation view, showing paylines available on a prior art five-reel slot machine.

FIG. 5 is a schematic view, showing the operation of one reel.

FIG. 6 is a detail view, showing a depiction of one possible layout for the player controls.

FIG. 7 is an elevation view, showing a representative game that may be used in conjunction with the present invention.

FIG. 8 is a schematic view, showing a representative layout for the control circuitry used in a game operating with the present invention.

REFERENCE NUMERALS IN THE DRAWINGS

| | | | |
|---|---|---|---|
| 10 | skill-based amusement machine | 12 | chassis |
| 14 | coin slot | 16 | bill receiver |
| 18 | non-card identifier | 20 | coin tray |
| 22 | player controls | 24 | primary display |
| 26 | secondary display | 28 | card ID receiver |
| 30 | optical reader/printer | 32 | first reel |
| 34 | second reel | 36 | third reel |
| 38 | fourth reel | 40 | fifth reel |
| 42 | first row | 44 | second row |
| 46 | third row | 48 | symbol |
| 50 | reel display | 52 | linear payline |
| 54 | chevron payline | 56 | offset payline |
| 58 | individual reel | 60 | spin button |
| 62 | skill stop button | 64 | nudge controls |
| 66 | reel select controls | 68 | bonus display window |
| 70 | prompt window | 72 | status displays |
| 74 | CPU | 76 | currency processor |
| 78 | card ID processor | 80 | non-card ID processor |
| 82 | optical reader/printer | 84 | memory |
| 86 | video driver | 88 | user input processor |
| 90 | remote server | 92 | communications link |
| 94 | display | 96 | touch screen |
| 98 | manual inputs | 100 | auxiliary effects |
| 102 | dispenser | | |

### DETAILED DESCRIPTION OF THE INVENTION

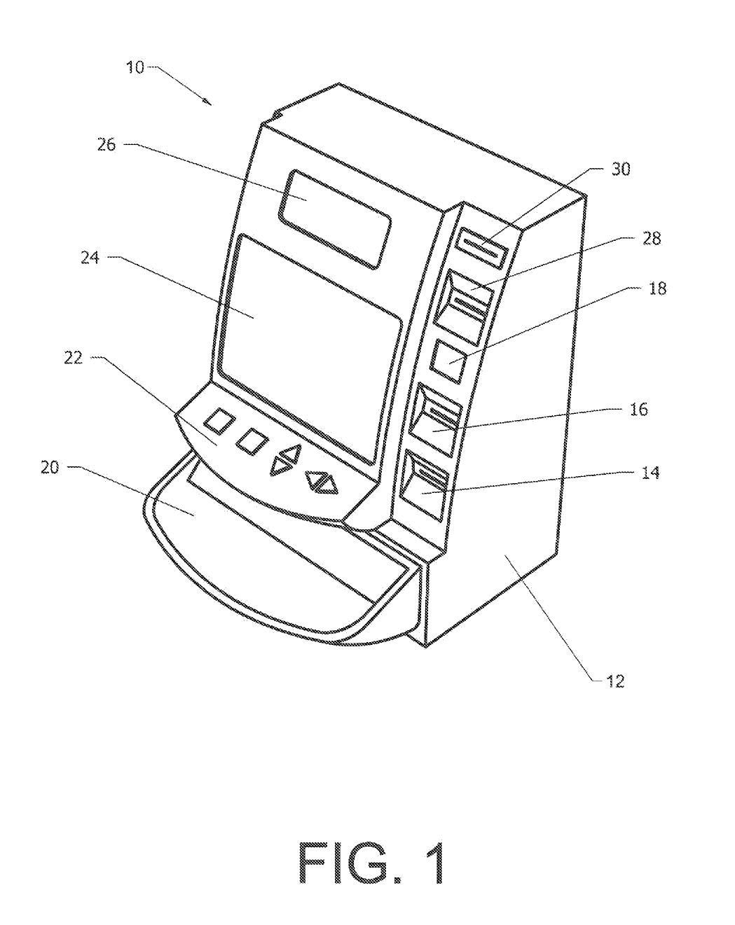

Skill-based amusement machines can be configured to present a virtually endless variety of games. A machine such as shown in FIG. 1 is well-suited to the presentation of “slot machine” type games, and this type of game will be used in the following examples. However, as stated previously, the inventive method is by no means limited to any particular game.

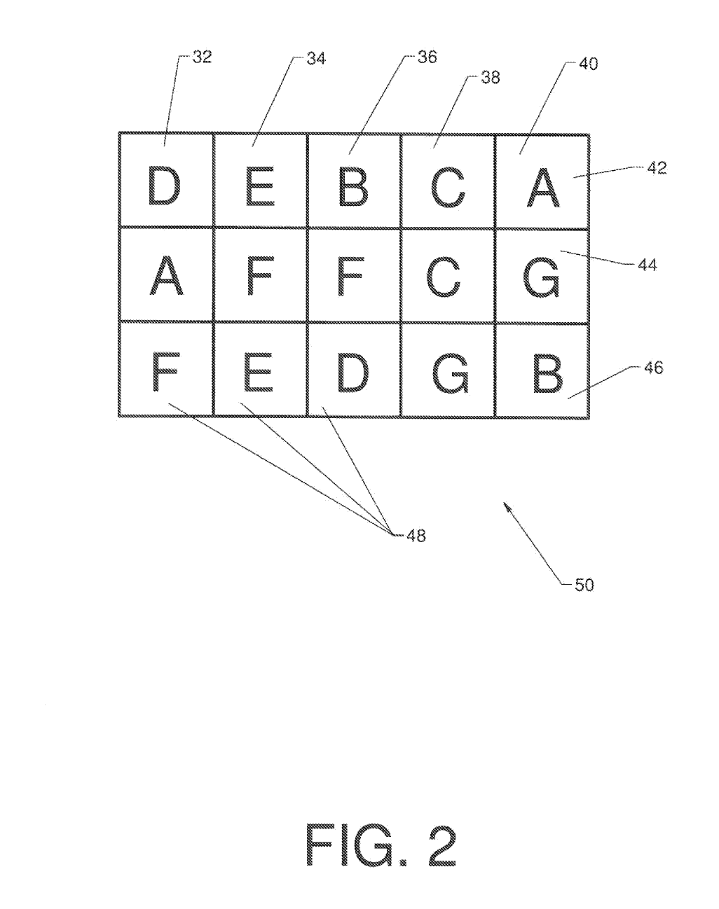

Modern gaming machines do not generally use mechanical reels in the presentation of slot machines. Instead, the appearance of a mechanical reel is simulated on primary display 24. The simulated display shows the reels in motion (spinning) and in a stopped state. In FIG. 2, reel display 50 shows the appearance of a five-reel game in which three symbols are visible at any one time for each reel. From left to right, the reels are designated as first reel 32, second reel 34, third reel 36, fourth reel 38, and fifth reel 40.

Each reel has three visible rows. From top to bottom, these are designated as first row 42, second row 44, and third row 46. Each reel displays three symbols 48 when it is stopped. Those skilled in the art will know that many different symbols are used in such games (various types of fruit being one popular motif). In the depictions of FIGS. 2-5, letter symbols 48 (A, B, C . . . ) are used. These are merely representative, and do not reflect common usage in the industry.

The player wins a slot machine game when the reels stop and a defined alignment of the symbols results. Players are often allowed to play multiple alignments. Any alignment that is defined as a winning game is often called a “payline.”

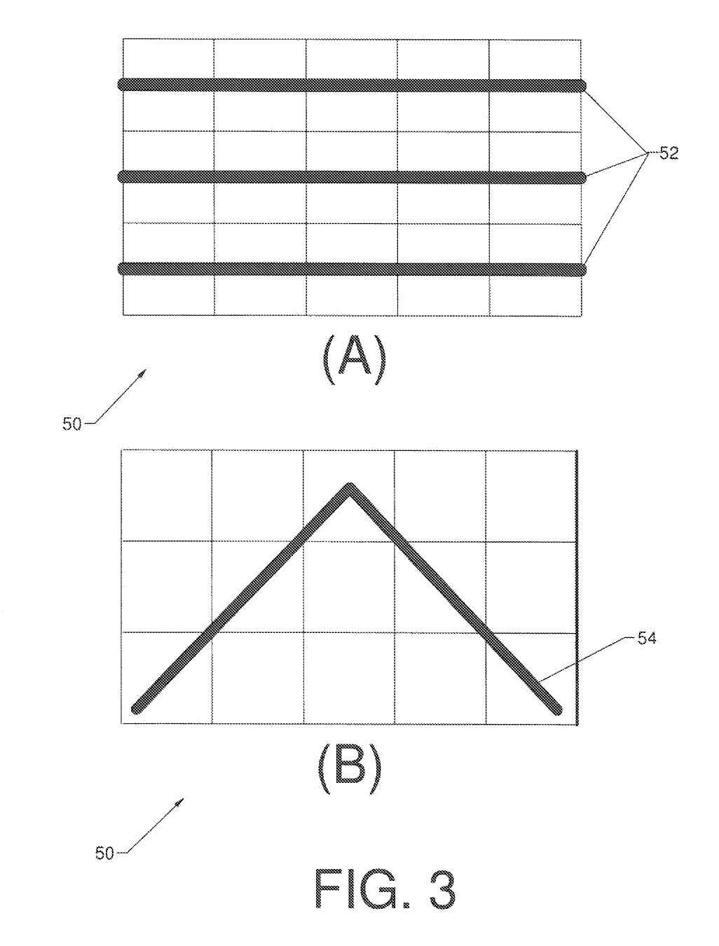

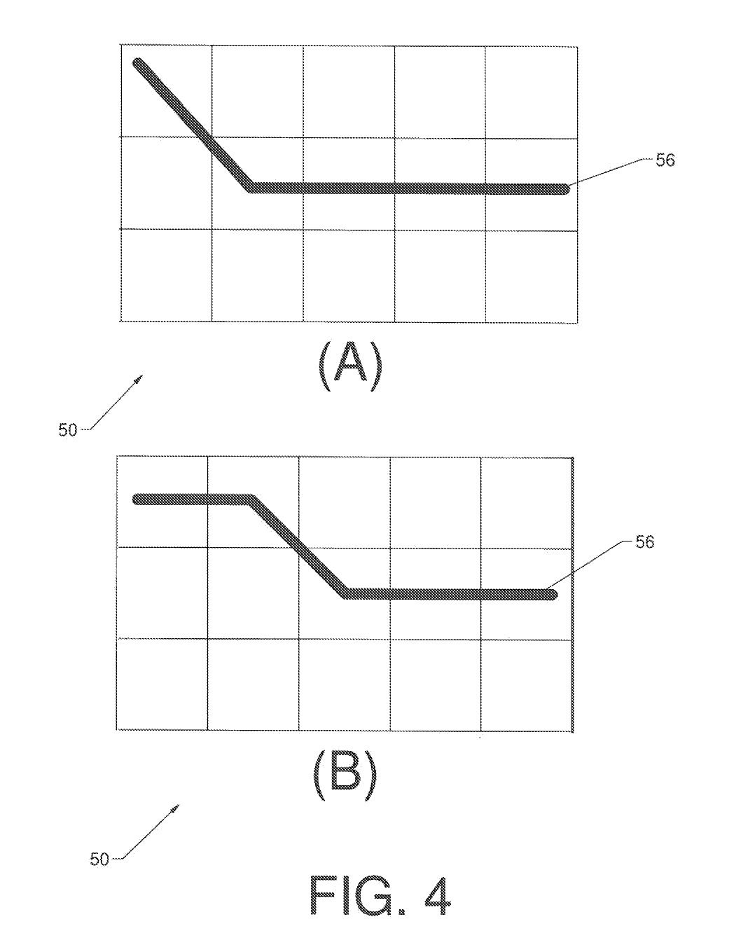

FIGS. 3 and 4 depict some commonly defined paylines. In FIG. 3A, linear paylines are defined. A horizontal alignment of symbols along one of the linear paylines 52 results in a “WIN.” FIG. 3A presents a winning payline of D's, a winning payline of A's, and a winning payline of F's (Note that a win need not be defined as five symbols in a row, since that is highly unlikely. A win may be defined as two or more symbols in a row, with the payout increasing with the increasing number of symbols).

FIG. 3B illustrates another type of payline. Chevron payline 54 has resulted from the desired alignment of D's. Players are often allowed to place bets on multiple possible paylines. If a player selected the inverted chevron configuration shown in FIG. 3B, then this would become a winning payline. FIGS. 4A and 4B show additional possible paylines. FIG. 4A shows one type of offset payline 56. FIG. 4B shoes another type of offset payline 56.

The figures presented do not show all the possible paylines. For a five-reel game where paylines can span the three visible rows, it is common to allow betting on up to 20 defined paylines. Thus, the results of any given spin can become complex. Every game of chance runs through a “defined cycle” in order to determine whether a wager results in a win or loss. For slot machines, each individual payline is considered a defined cycle (and a “game”). Thus, if a player bets 20 paylines, a single spin results in 20 defined cycles.

The spins shown in FIG. 2 through 4 produced a “five of a kind” result—which is usually how a jackpot is defined. The pay tables often define many other “winning” combinations with lower payouts. Thus, some games will pay an amount for having two symbols adjacent to each other on a payline, three symbols adjacent, etc. A discussion of the various types of pay tables used in such games is beyond the scope of this disclosure. Suffice it to say that many, many variations are possible.

As those skilled in the art will know, many other entertaining elements can be added to this type of game. One modification inserts a “wildcard” symbol into the set of symbols. A wildcard symbol may be used to match any other symbol needed to create a winning combination on a payline. The determination of winning paylines is usually automated via the software running in the gaming machine.

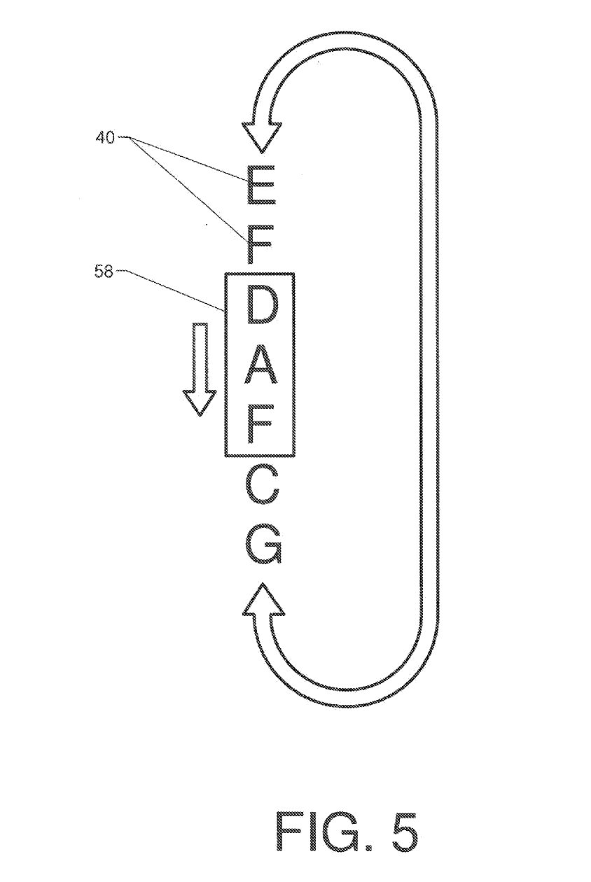

The spinning reel depictions must be populated with a random assortment of symbols each time the game is played. FIG. 5 schematically depicts one way this process can be performed. The machine used in the illustrations presents seven symbols for each reel. A random number generator is used to create a group of seven symbols for the reel. As shown in FIG. 5, the box entitled individual reel 58 presents the limited view available to the player on the display. In order to simulate the old-fashioned spinning reels, symbols 48 are made to move down in the window in the direction indicated by the arrow. The symbols are recycled to the top so that the same sequence of symbols is presented as the simulated spinning continues.

The result is the simulation of the view a user once had of a traditional spinning reel. A traditional spinning reel had the symbols printed at equally spaced intervals around its perimeter. They thus rotated by in the same order. For many machines used in the gaming industry, the process shown in FIG. 5 produces the same effect.

Mechanical reels spin at a rapid rate. The video depiction simulating this spinning also presents the symbols moving at a rapid rate. However, it is sometimes desirable to add an element of skill to such amusement games. If an element of skill is desired, the user is given the ability to stop a spinning reel or reels by actuating an input such as a “stop button.” The simulated spin rate is then set so that an individual with good vision and fast reflexes can actually improve the win rate by skillfully using the stop button.

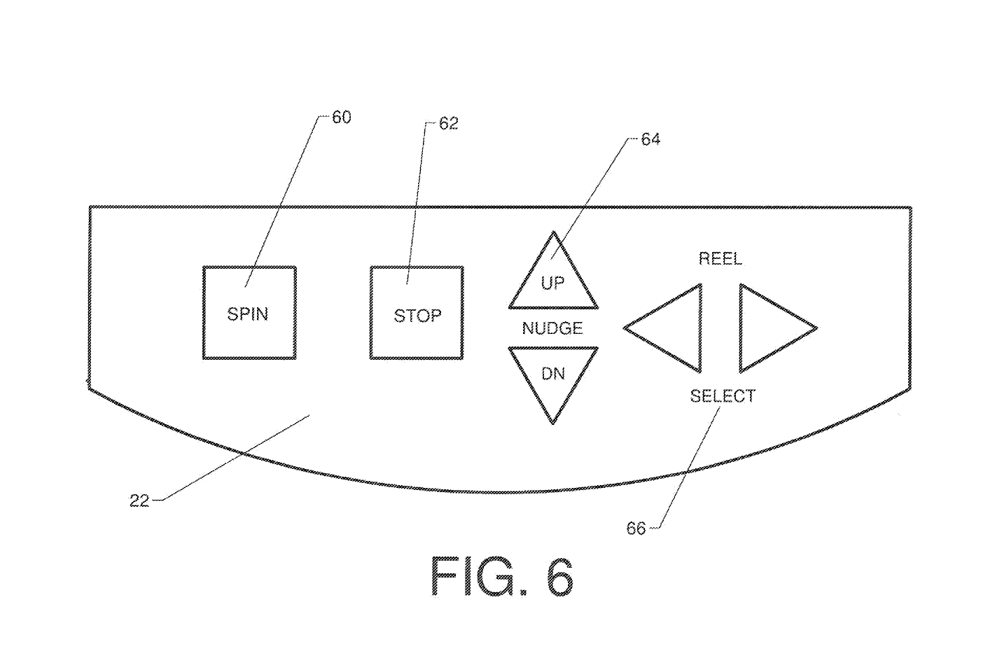

FIG. 6 shows one embodiment of a panel including player controls 22. Such controls are often provided on a reconfigurable video touch screen, but in the version of FIG. 6 the user controls are physical buttons. Spin button 60 is used to start each new actuation of the game. Skill stop button 62 allows the user to control the stopping of one or more reels.

Nudge controls 64 refer to another option of introducing an element of skill. The player may be given the option to “nudge” a reel up or down one symbol. The operation of the nudge feature will be explained with respect to FIG. 5. The reader will recall that the player can only see the three symbols shown for individual reel 58 (D A F). If after the reel stops the player actuates controls to nudge the reel down one letter, then the displayed symbols will become “F D A.” If the player nudges the reel up, then the displayed symbols will become “A F C.”

The desirability of a nudge may be apparent if the player is moving one visible symbol to another visible location. It is less apparent when a player elects to nudge a non-visible symbol into view. Again, the apparent spin rate may be set so that a skillful player can see and remember the symbols that are just out of view. When appropriately configured, the use of “skill stop” and “nudge” features unquestionably introduce an element of skill to such amusement games.

Returning now to FIG. 6, the reader will perceive that nudge controls 64 may be used to nudge a particular reel up or down a defined amount. Reel select controls 66 may be used to change the reel selection for any applicable function.

The physical buttons may be given two or more functions, depending on, the screen displayed. As an example, the machine may present a “betting” screen where the buttons are used to select paylines and place bets. Endless variations are possible.

It is presently preferable to incorporate many—if not all—of the required control features into the display itself. This can be done by incorporating “touch screen” technology in the display. There are many forms of touch screen technology. One currently popular approach uses a capacitive touch screen laid on top of the video display (and sometimes joined into a single, unified laminate). The capacitive touch screen is able to detect one or more instances of the user touching the screen. The information as to where the screen is touched is tied to certain displayed features—such as “virtual” buttons.

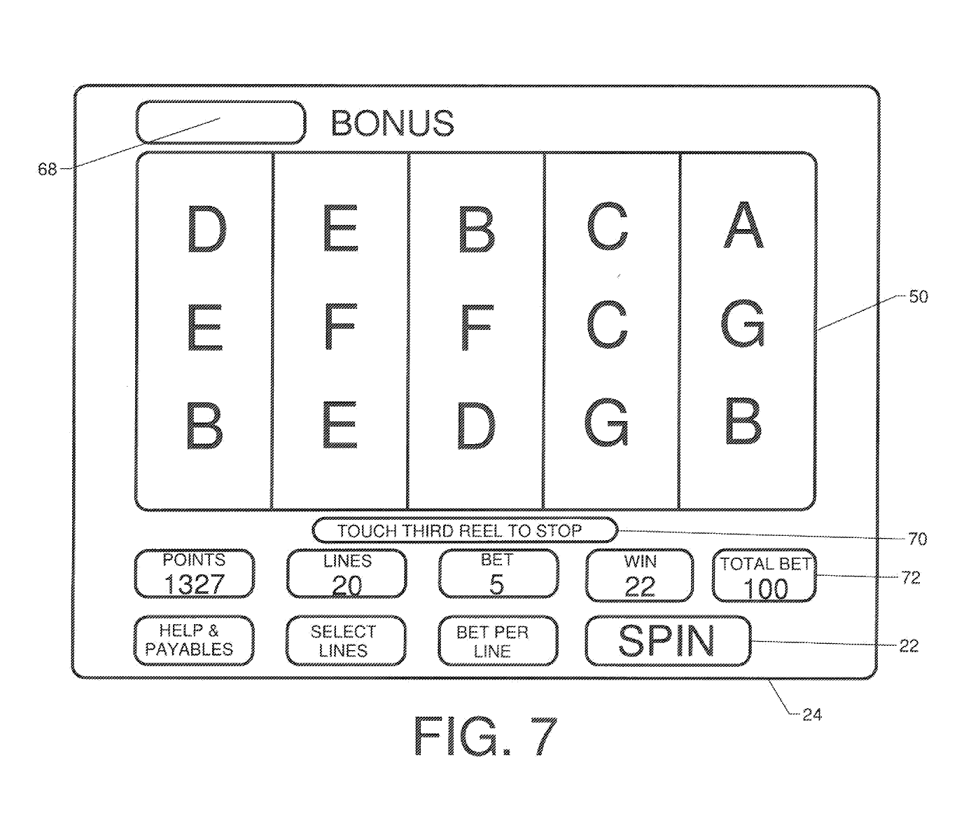

FIG. 7 shows a depiction of a display which would be presented by primary display 24 of the machine of FIG. 1. Reel display 50 is presented as the central part of a larger collection of information. Prompt window 70 provides information regarding the next action the player would reasonably be expected to take. Status displays 72 provide the current status of the user inputs and other features.

Player controls 22 are analogous to the mechanical buttons shown in FIG. 6. However, these are “virtual” buttons, meaning that a depiction of a button is presented on the video display and the touch screen input then interprets a touch to this area as the player's intent to “press” the button.

The display can be configured in any desired fashion, but a brief explanation of the particular version shown in FIG. 7 may aid the reader's understandings. The “help and paytables” button accesses help features and also displays the pay table (a schedule defining the possible returns for a wager placed on each of the possible paylines or combinations thereof). The “select lines” button allows the user to select one or more possible paylines for placing a bet. The “bet per line” button allows the user to specify the amount wagered on each payline. The “spin” button of course actuates a new iteration of the game.

Status displays 72 are a series of windows providing useful information. The “points” window displays increments of play. A “point” is the minimum wager a player can make per lines of play. As an example, the minimum wager may be one penny per line. In the example, the player has accumulated 1,327 points reflecting the total of the wagers made thus far. The “lines” window shows how many paylines the player has placed a wager upon. The “bet” window shows the amount of the bet placed on each line. The “win” window shows the amount the player actually won for the previous spin. The “total bet” window shows the total amount the player has wagered on the next spin of reel display 50.

For regulatory purposes, each possible payline is often considered an individual defined cycle of the amusement game. Thus, if 20 paylines are available, a single actuation of the “spin” button will result in 20 games being played at once. Twenty individual win/loss determinations will also be made.

Finally, bonus display window 68 is provided at the top of primary display 24. This window is preferably used to display a value relating to the present inventive method. As the valued displayed is significant to developing player loyalty, it is preferable to display it prominently.

Returning to FIG. 1, secondary display 26 may be used to provide the bonus display window in a location that is separate from primary display 24. However, there is no particular significance to where or how the bonus value is displayed. In fact, it may be preferable in some instances to communicate this value to the player in a manner that cannot be detected by other persons. So long as the value is communicated to the user, the particular method of communication is not important.

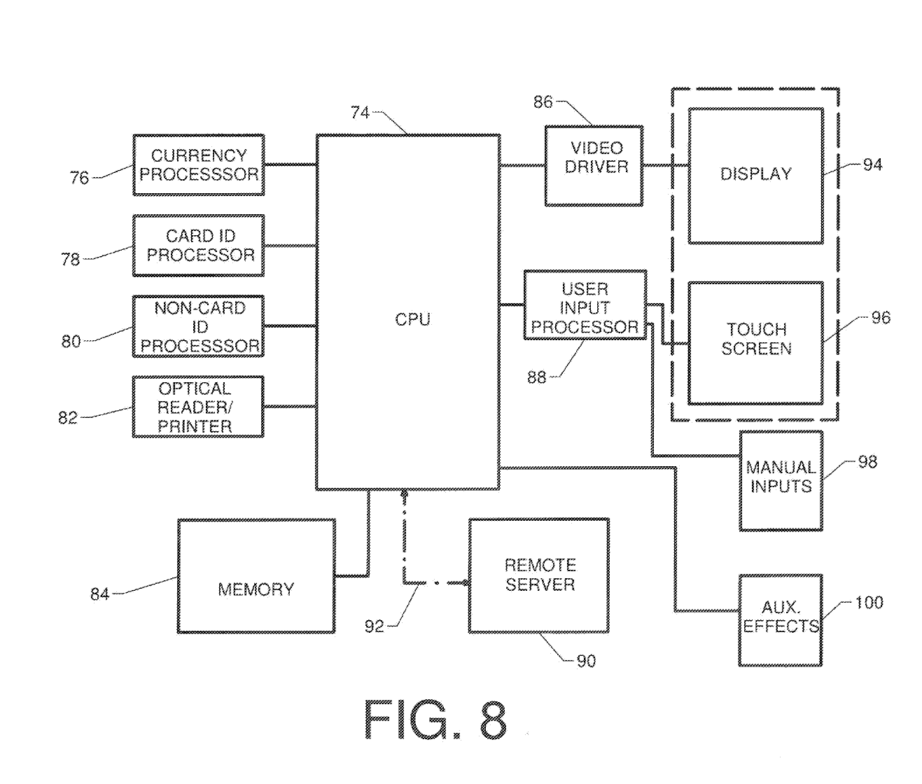

FIG. 8 schematically depicts the main components of a gaming machine used to implement the inventive method. CPU 74 is a computer which runs software in order to carry out the various functions of the game. Associated memory 84 is accessed by the CPU to read and write data. The other components are briefly described in the following:

(1) Currency processor 76—This unit receives coins and bills. It authenticates what it has received and transmits the value of what it has received to CPU 74.

(2) Card ID processor 78—This unit receives a card and authenticates that card, typically to identify a particular player. Many gaming providers now provide a portable card to identify each player and allow the convenient transfer of gaming credits. Rather than requiring the user to carry a stack of tokens, the provider furnishes a card which contains information about the gaming credits available to the user. Card ID processor 78 reads this information and uploads it to a particular gaming machine. Card ID processor 78 may also be able to write information back to the card. If the player hits a jackpot, the player may elect to have the machine write the appropriate credit back to the card. The use of such a card allows the player to easily transport the available gaming credits from machine to machine. As will be explained subsequently, other significant gaming features may be written to the card and transported as well. Those skilled in the art will realize that the card may assume the form of a printed ticket (a “ticket-in/ticket-out system”) rather than a more sophisticated data storage card.

(3) Non-card ID processor 80—The unique identification of a player can be made by many techniques other than a portable card. This unit may include any of these known techniques. For example, devices exist to allow the rapid identification of a player's unique thumb print. Returning briefly to FIG. 1, non-card identifier 18 shown in that embodiment is a thumb print pad. The player places his or her thumb on this pad and positive identification is made. Other more exotic technologies may be used, including facial recognition and retinal scans.

(4) Optical reader/printer 82—This device is used to read printed paper cards and to print information to a paper card. Such paper cards are used by some gaming providers to convey credits for game play, and to convey the results of playing on one particular machine.

(5) Dispenser 102—This device is used to dispense currency or tokens when a player wins and chooses this option.

(6) Video driver 86—This device is used to control the depiction of graphical elements on display 94 and other displays.

(7) User input processor 88—This device is used to receive inputs from the user and transfer these inputs to the CPU. For example, inputs may be received from touch screen 96 and/or manual inputs 98 (such as individual mechanical buttons).

(8) Auxiliary effects processor 100—This device controls other effects such as sound, lighting, vibrations effects, etc.

(9) Remote server 90—CPU 74 is preferably linked to a remote server 90 via communications link 92. The remote server may be used to track gaming credits automatically so that the user does not need to carry a card or other device. The communication link may be wired or wireless. It may assume any other desired form, such as an optical link.

Now that the components of a representative gaming machine have been described, the present inventive method will be explained in detail. Each gaming provider wants a customer to continue playing its machines rather than going to a competitor. Unfortunately, most gaming providers offer similar gaming machines. Differentiation is therefore difficult. The present inventive method is intended to provide an incentive for the player to continue playing machines offered by one provider.

There is an unfounded belief on the part of some players that a slot machine that has not “hit” through many spins is “due.” A player will sometimes continue playing on the basis of this belief. In reality, the operation of each machine is dependent upon a random number generator and the odds of a successful wager are the same for each and every iteration. It is true, however, that some players build a loyalty to a particular machine on the false belief that it is “due.” The present invention seeks to build customer loyalty by modifying the jackpot payout so that there is ah actual, rational basis for continuing to play a single machine (or another machine offered by the same gaming provider).

A slot machine game such as illustrated in FIG. 7 has a clearly defined list of possible payouts—usually published in a “pay table.” A jackpot is generally defined as well. For a slot machine, a jackpot payout is often triggered when a single payline is occupied by five instances of the same symbol. In the present invention, an “altering function” is used to alter the defined jackpot in a way that promotes player loyalty.

Still using the example of FIG. 7, the reader will note that for each 5 coin bet, the player in the game shown stands to win a 22 coin payout for each winning payline. In the game shown, the player has bet 20 lines and 5 coins per line. If the player wins 5 of the 20 lines, the return will be 110 coins.

A separate “jackpot” is defined as well, using the typical definition of having one horizontal line with the same five symbols. It is now common for gaming providers to tie all the gaming machines into a central server system which keeps track of cumulative wins and losses over time. Some providers have a grand jackpot which goes up over time until somebody hits the grand jackpot. The value of the grand jackpot is often publicized—sometimes on a large display visible to all—and this builds loyalty to the particular facility.

The present invention builds loyalty on the basis of a single player's experience. It does so by providing a jackpot bonus which is specific to the individual player and which is altered as a function of how many individual games the player has lost. An example will illustrate how the method operates. The applicable regulatory environment considers a single payline to be a “game.” Twenty paylines are available. Thus, a user betting all twenty paylines plays twenty games per spin (with each individual gamer then being a “defined cycle”). The machine is set to allow a 1 coin wager on each payline. In the example, the regulations cap the maximum payout per payline at 75 coins per game played.

The “jackpot” in the example is defined as a single payline that is occupied entirely by one symbol (“five in a row”). In the example, the player wagers 1 coin on each of 20 paylines. The defined bonus starts at 0 so bonus display window 68 displays 0. Since the regulatory environment caps the prize award for each game at 75 coins, the starting jackpot is defined as 75 coins.

The defined cycle that is used to determine whether a player wins or loses a particular wager. In this example, a defined cycle occurs for each payline in each spin. The player has placed a wager on all 20 paylines available. The player “spins” the machine and this creates 20 defined cycles of the game (one for each payline).

The spin results in 1 line winning and 19 lines losing. In this example, each losing line is accumulated and used to increase the available jackpot payout by a bonus amount (an “altering function”). Thus, after the first spin the number of losing lines stands at 19. The player spins again and the result is 6 winning lines and 14 losing lines. The number of losing lines then stands at 33 (19+14).

The jackpot payout in this example is defined as an initial value plus 75 coins multiplied by the number of losing lines. Thus, if the player hits a jackpot on the third spin, the jackpot is 75 coins plus 75 coins multiplied by 33, or 2,550 coins. This large payout does not violate the regulatory restriction of 75 coins per game because 40 games have been played (2 spins playing 20 paylines for each spin). The regulatory maximum for 40 games is 3,000 coins (40*75).

The bonus system accumulates losing lines and uses them to alter the amount of the jackpot payout. When a jackpot is hit under the scheme employed in this example, the bonus is reset to zero and the process begins anew.

Lost lines are preferably made transferable with the player from machine to machine. The number of lost lines can be written to a player ID card or paper card to be used with the readers described previously. Alternatively, the lost lines can be stored in memory in a central server after being transferred by communications link 92. A player can then access the lost lines so long as the player can be positively identified using an identification card, thumb print, facial recognition software, etc.

The method may be generalized as (1) defining a particular altering function that is used to alter the amount of the jackpot (where the altering function is based at least in part on the number of lost wager events by a particular player); (2) keeping track of each lost wager event by a particular player; and (3) altering the jackpot for the particular player on the basis of the number of lost wager event accumulated by that player, according to the defined altering function.

For the prior example, the jackpot is defined as follows:

Jackpot=initial value+altering function.

The altering function is defined as:

75 coins*n, where n is the total number of previous lost lines.

It is preferable to display the altering function to the user in a way that is easy to understand (and which provides ah incentive to continue playing). In the prior example, the player would be informed (preferably via the visual display) that the jackpot was starting at a value of 75 coins. Bonus display window 68 would display “0.” After the second spin, bonus display window 68 would display “2,475 coins” (19 lost lines multiplied by 75 coins). One could also configure the machine to simply display the total available jackpot. The total value would include the altering function, though the exact value produced by the altering function would not necessarily be displayed directly.

The odds of winning the game have not been changed by the altering function (though the reader should note that the inclusion of skill factors such as a skill-stop reel and a nudge function do change the odds in the player's favor). However, the user has clearly been informed that the jackpot amount has been increased. And—the jackpot amount is computed on an individual basis. If the player decides to take a break, the current state of the altering function is stored. When the player resumes (possibly later in the same day or even after a more extended interval) the altering function is reset to the state existing when the player last stopped playing. The state of the altering function may be saved by a wide variety of means and the invention is in no way limited to any particular means. A few examples of the available means are:

(1) Magnetic card—The current state is encoded on a magnetic card that is supplied to the player via card ID receiver 28 (see FIG. 1).

(2) Thumb print—The current state is stored in a central server and the player can retrieve that state using a thumb print identification on non-card identifier 18.

(3) Paper card—The current state is printed as a QR code on a paper card and the player retrieves the state by inserting the card in optical reader/printer 30.

(4) Facial recognition software—The current state is stored in a central server and the user retrieves that state by simply sitting down in front of a machine which recognizes the user's facial characteristics. This version may be supplemented by the use of a password.

The state of the altering function may then be transferred by the user to another machine playing the same game, or even to a different type of machine altogether. Significantly, the altering function would only be available to the user when playing on the machines offered by a particular vendor. Thus, in order to access the altering function, the user must remain loyal to a particular vendor.

The altering function itself may assume a wide variety of forms. If n is the number of lost wager events for a particular user, then several more examples of the altering function would be:

Jackpot=initial value+0.5*n*75

Jackpot=initial value+5*n*n, up to a capped maximum of 5,000

Jackpot=initial value+n*75−n*n*0.15

Jackpot=initial value+0.002*n*n

The altering function could even be set to operate on the basis of multiple players playing as a group. If for example, four players are defined as a group, a common altering function could be applied on the basis of the wagering events for the group.

All of these functions will likely be dependent upon the need to meet local regulatory requirements for gaming. It is beyond the scope of this disclosure to address all these various requirements. However, those skilled in the art will realize that the altering function could be tailored to meet virtually any regulatory scheme.

The paradigm motif a slot machine has been used to illustrate the features of the present invention. However, as stated initially, this paradigm should not be viewed as limiting. While it is impossible to illustrate every application for the inventive method, it may benefit the reader's understanding to consider one additional application outside the field of traditional gaming.

Arcade games may involve a single player playing against a situation created by the software or multiple players pitted against each other. One example of such a game is a “driving” game in which multiple players compete to win a race around a virtual track. The “prize” for winning such a game is typically additional gaming credits.

A novice competitor does not typically perform well when he or she starts a new driving game. As is true for most gaming scenarios, a competitor must develop time to develop the skill necessary to win. However, it is often true that a novice competitor becomes discouraged by the initial poor results and gives up.

The present invention can be employed to entice a novice player to keep trying. As an example, a first-time player may be asked to compete for a prize of 100 game credits. If the player loses in the initial competition, the following message could be presented on the video display:

“Tough luck. It usually takes a few races for a player to develop the skill to be competitive. Keep trying! Every time you lose a race we will increase the prize you are racing for. In your second race, your personal prize will be 200 game credits. In your third race, your personal prize will be 300 game credits.”

The reader will thereby perceive that the arcade example of the present invention: (1) provides a gaming machine that presents a first-person racing game in which multiple competitors compete against each other; (2) displays a prize which is preferably unique to each player; and (3) includes an altering function which modifies the prize available to each player on the basis of that player's performance in prior games. Further, the prize is displayed to each player in order to entice that player to continue playing the game.

The preceding description contains significant detail regarding the novel aspects of the present invention. It should not be construed, however, as limiting the scope of the invention but rather as providing illustrations of the preferred embodiments of the invention. Many applications are possible beyond the slot machine and arcade scenarios described. Bingo games could be modified to include the inventive method, as could many other types of games. Thus, the scope of the invention should be fixed by the claims presented, rather than by the examples given.

Having described my invention, I claim:

1. A method of promoting continued play of a gaming machine by a user, comprising:
a. providing a gaming machine, including a processor running software;
b. said gaming machine including an associated memory accessible by said software running on said processor;
c. said gaming machine including a display which is visible to said user;
d. said software implementing a defined game of chance on said gaming machine;
e. said defined game of chance having a defined jackpot which is stored in said associated memory;
f. wherein said user places a wager on a defined cycle that is part of said defined game of chance;
g. running said defined game of chance through said defined cycle, and thereby determining whether said user has won or lost said wager;
h. in the event said user loses said wager, altering said defined jackpot according to a defined altering function;
i. saving said altered jackpot to said associated memory; and
j. displaying information concerning the operation of said defined altering function on said display.

2. A method of promoting continued play as recited in claim 1, wherein said defined altering function increases said jackpot a fixed increment for each loss experienced by said user.

3. A method of promoting continued play as recited in claim 2, wherein said jackpot is capped at a defined maximum despite said operation of said defined altering function.

4. A method of promoting continued play as recited in claim 1, wherein said information displayed is said current value of said jackpot.

5. A method of promoting continued play as recited in claim 1, wherein said information displayed is the difference between said current value of said jackpot and the value of said jackpot before said player started playing.

6. A method of promoting continued play as recited in claim 1, wherein:
a. said defined game of chance includes a plurality of spinning reels, wherein combinations of symbols on said reels define a winning payline; and
b. said defined game of chance includes a user-actuated stop function on at least one of said reels.

7. A method of promoting continued play as recited in claim 1, wherein:
a. said defined game of chance includes a plurality of spinning reels, wherein combinations of symbols on said reels define a winning payline; and
b. said defined game of chance includes a user-actuated nudge function on at least one of said reels.

8. A method of promoting continued play of a gaming machine by a user, comprising:
a. providing a gaming machine, including a processor running software;
b. said gaming machine including an associated memory accessible by said software running on said processor;
c. said gaming machine including a display which is visible to said user;
d. said software implementing a defined game of chance on said gaming machine;
e. said defined game of chance having a defined jackpot which is stored in said associated memory;
f. wherein said user places a wager on a defined cycle that is part of said defined game of chance;
g. running said defined game of chance through said defined cycle, and thereby determining whether said user has won or lost said wager;
h. in the event said user loses said wager, increasing said defined jackpot according to a defined function which includes the number of said losses experienced by said user;
i. saving said altered jackpot to said associated memory; and
j. displaying information concerning the operation of said defined altering function on said display.

9. A method of promoting continued play as recited in claim 8, wherein said defined altering function increases said jackpot a fixed increment for each loss experienced by said user.

10. A method of promoting continued play as recited in claim 9, wherein said jackpot is capped at a defined maximum despite said operation of said defined altering function.

11. A method of promoting continued play as recited in claim 8, wherein said information displayed is said current value of said jackpot.

12. A method of promoting continued play as recited in claim 8, wherein said information displayed is the difference between said current value of said jackpot and the value of said jackpot before said player started playing.

13. A method of prompting continued play as recited in claim 8, wherein:
a. said defined game of chance includes a plurality of spinning reels, wherein combinations of symbols on said reels define a winning payline; and
b. said defined game of chance includes a user-actuated stop function on at least one of said reels.

14. A method of promoting continued play as recited in claim 8, wherein:
a. said defined game of chance includes a plurality of spinning reels, wherein combinations of symbols on said reels define a winning payline; and
b. said defined game of chance includes a user-actuated nudge function on at least one of said reels.

15. A method of promoting continued play of a gaining machine by a user, comprising:
a. providing a gaming machine, including a processor running software;
b. said gaming machine including an associated memory accessible by said software running on said processor;
c. said gaming machine including a display which is visible to said user;
d. said software implementing a defined game of chance on said gaming machine, wherein said game of chance includes a plurality of spinning reels, wherein combinations of symbols on said reels define a winning payline;
e. said defined game of chance having a defined jackpot which is stored in said associated memory;
f. said defined game of chance including a user-actuated stop function on at least one of said reels;
g. said defined game of chance including a user-actuated nudge function on at least one of said reels;
h. wherein said user places a wager on a defined cycle that is part of said defined game of chance;
i. running said defined game of chance through said defined cycle, including said user-actuated stop and nudge functions, and thereby determining whether said user has won or lost said wager;
j. in the event said user loses said wager, increasing said defined jackpot according to a defined altering function;
k. saving said altered jackpot to said associated memory; and
l. displaying information concerning the operation of said defined function on said display.

16. A method of promoting continued play as recited in claim 15, wherein said defined altering function increases said jackpot a fixed increment for each loss experienced by said user.

17. A method of promoting continued play as recited in claim 15, wherein said jackpot is capped at a defined maximum despite said operation of said defined altering function.

18. A method of promoting continued play as recited in claim 16, wherein said jackpot is capped at a defined maximum despite said operation of said defined altering function.

19. A method of promoting continued play as recited in claim 15, wherein said information displayed is said current value of said jackpot.

20. A method of promoting continued play as recited in claim 15, wherein said information displayed is the difference between said current value of said jackpot and the value of said jackpot before said player started playing.
